(19) United States
(12) Patent Application Publication
(10) Pub. No.: US 2017/0316805 A1
(43) Pub. Date: Nov. 2, 2017

(54) METHOD AND APPARATUS FOR ADJUSTING PLAYING PROGRESS OF MEDIA FILE

(71) Applicant: Beijing Xiaomi Mobile Software Co., Ltd., Beijing (CN)

(72) Inventors: Chenxi WANG, Beijing (CN); Ming LIU, Beijing (CN); Wei HAN, Beijing (CN)

(73) Assignee: Beijing Xiaomi Mobile Software Co., Ltd.

(21) Appl. No.: 15/498,545

(22) Filed: Apr. 27, 2017

(30) Foreign Application Priority Data
Apr. 28, 2016 (CN) 201610274623.7

(51) Int. Cl. G11B 27/00; G06F 3/16; G06F 3/0488; H04N 21/472; G06F 3/0484

(52) U.S. Cl. CPC G11B 27/005; H04N 21/47217; G06F 3/04845; G06F 3/04883; G06F 3/165

(57) ABSTRACT

The present disclosure provides a method and apparatus for adjusting playing progress of a media file. The method includes acquiring a first operation performed by a user with respect to a progress bar of the media file; determining whether the first operation satisfies a preset operation condition; when the first operation satisfies the preset operation condition, determining a progress adjusting rule corresponding to the preset operation condition; and determining a playing progress point of the media file according to the progress adjusting rule and a second operation performed by the user with respect to the progress bar of the media file.

### CROSS-REFERENCE TO RELATED APPLICATION

This application is based upon and claims priority to Chinese Patent Application No. 201610274623.7, filed Apr. 28, 2016, the entire contents of which are incorporated herein by reference.

### TECHNICAL FIELD

The present disclosure generally relates to the field of communications technology, and more particularly, to a method and apparatus for adjusting playing progress of a media file.

### BACKGROUND

Recently, the rapid development of terminal technology makes terminal devices have more and more functions and types. For example, a user may install media player software on a smart phone for playing a media file on the smart phone, and may further adjust a playing progress of the media file according to his/her own needs. The media file may be, e.g., an audio file or a video file.

In related prior art, when adjusting the playing progress of a media file, it may be difficult for a user to adjust the playing progress accurately, resulting in, for example excessive adjustments. In order to solve the above problems, the present disclosure provides a method and apparatus for adjusting playing progress of a media file.

### SUMMARY

According to a first aspect of the present disclosure, there is provided a method for adjusting a playing progress of a media file. The method includes acquiring a first operation performed by a user with respect to a progress bar of the media file; determining whether the first operation satisfies a preset operation condition; when the first operation satisfies the preset operation condition, determining a progress adjusting rule corresponding to the preset operation condition; and determining a playing progress point of the media file according to the progress adjusting rule and a second operation performed by the user with respect to the progress bar of the media file.

According to a second aspect of the present disclosure, there is provided an apparatus for adjusting playing progress of a media file. The apparatus includes a processor and a memory for storing instructions executable by the processor. The processor is configured to acquire a first operation performed by a user with respect to a progress bar of the media file; determine whether the first operation satisfies a preset operation condition; when the first operation satisfies the preset operation condition, determine a progress adjusting rule corresponding to the preset operation condition; and determine a playing progress point of the media file according to the progress adjusting rule and a second operation performed by the user with respect to the progress bar of the media file.

According to a third aspect of the present disclosure, there is provided a non-transitory computer-readable storage medium having stored thereon instructions that, when executed by a processor in a terminal device, cause the terminal device to perform a method for adjusting a playing progress of a media file. The method includes acquiring a first operation performed by a user with respect to a progress bar of the media file; determining whether the first operation satisfies a preset operation condition; when the first operation satisfies the preset operation condition, determining a progress adjusting rule corresponding to the preset operation condition; and determining a playing progress point of the media file according to the progress adjusting rule and a second operation performed by the user with respect to the progress bar of the media file.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for adjusting a playing progress of a media file, according to an exemplary embodiment.

FIG. 2 is an application scenario where the method in FIG. 1 is applied, according to an exemplary embodiment.

FIG. 3 is an application scenario where the method in FIG. 1 is applied, according to another exemplary embodiment.

FIG. 4 is a flow chart of a method for adjusting a playing progress of a media file, according to another exemplary embodiment.

FIG. 5 is a block diagram of an apparatus for adjusting a playing progress of a media file, according to an exemplary embodiment.

FIG. 6 is a block diagram of a judgment module, according to an exemplary embodiment.

FIG. 7 is a block diagram of a first determination module, according to an exemplary embodiment.

FIG. 8 is a block diagram of a second determination module, according to an exemplary embodiment.

FIG. 9 is a block diagram of an apparatus for adjusting a playing progress of a media file, according to an exemplary embodiment.

FIG. 10 is a block diagram of an apparatus for adjusting a playing progress of a media file, according to an exemplary embodiment.

FIG. 11 is a block diagram of an apparatus for adjusting a playing progress of a media file, according to an exemplary embodiment.

FIG. 12 is a block diagram of an apparatus for adjusting a playing progress of a media file, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Methods for adjusting a playing progress of a media file provided by the present disclosure will be described in detail below. The methods may be applicable to a terminal device. The terminal device may include, but is not limited to, a smart phone, a table computer, and the like.

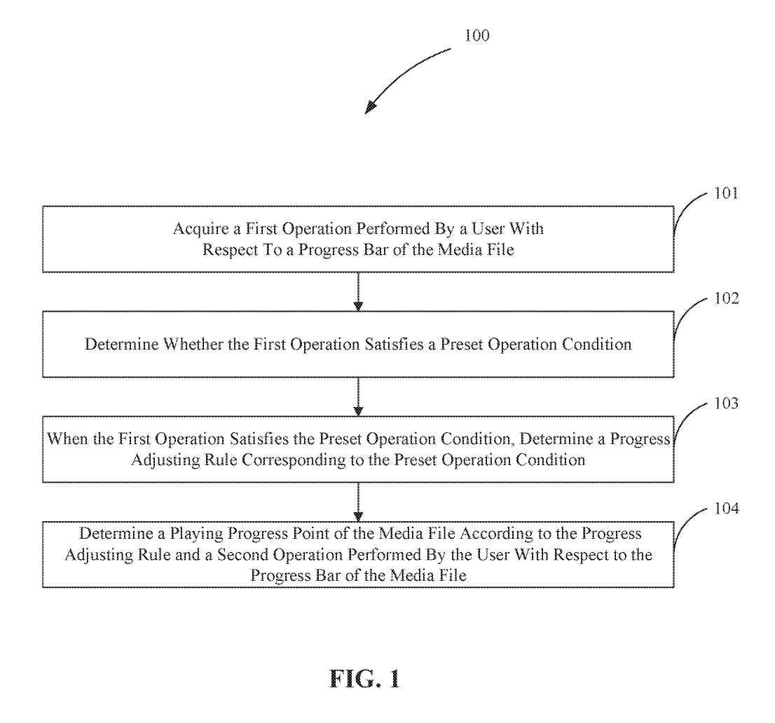

FIG. 1 is a flow chart of a method 100 for adjusting a playing progress of a media file, according to an exemplary embodiment. As shown in FIG. 1, the method 100 may include the following steps.

In step 101, a first operation performed by a user with respect to a progress bar of a media file is acquired.

The media file may be, e.g., a video file or an audio file. The user may perform a variety of operations on a progress bar of the video file or the audio file, such as a quick dragging, a slow dragging, a forward dragging, or a backward dragging.

The progress bar may be a sliding block for adjusting a playing progress of the media file. The sliding block may be located at an arbitrary position on a graphical user interface displayed by a terminal device.

The first operation may be a touch operation, for example, clicking and dragging the progress bar by the user. The first operation may also be a non-touch operation, such as a gesture of dragging the progress bar. When the first operation is a non-touch operation, the terminal device may first recognize whether a gesture of the user is a gesture of dragging the progress bar. If the gesture of the user is a gesture of dragging the progress bar, then the terminal device may further recognize a type of the gesture of dragging the progress bar. For example, the terminal device recognizes whether the gesture of dragging the progress bar is a quick dragging, a slow dragging, a forward dragging, a backward dragging, or the like.

In step 102, it is determined whether the first operation satisfies a preset operation condition.

In the exemplary embodiment, an operation satisfying the preset operation condition may be an operation which can reflect that a target progress point is about to be reached during dragging the progress bar. For example, with respect to a condition in which an excessive adjustment over a target progress point occurs, a user may drag back the progress bar to reach closer to the target progress point. In another example with respect to a condition that a target progress point is about to be reached, a user may slow down dragging the progress bar.

In some embodiments, step 101 may further include determining whether the first operation is an operation in which the progress bar is backward dragged during dragging the progress bar. If the progress bar has been dragged backward, the first operation is determined to satisfy the preset operation condition.

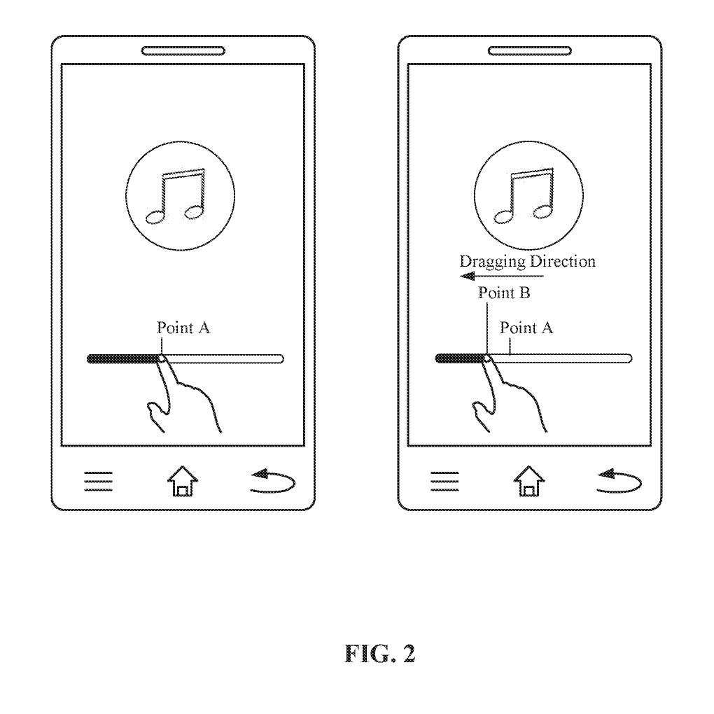

For example, as shown in FIG. 2, a user drags a progress bar for an audio file to a point A, and then drags the progress bar backward (along the dragging direction indicated by an arrow) to a point B without releasing the progress bar at the point A.

In some embodiments, step 101 may further include determining whether the first operation is an operation in which a variation in a dragging speed is greater than a preset value during dragging the progress bar. If so, the first operation is determined to satisfy the preset operation condition. This may be applied to a scenario where the dragging speed changes from a fast speed to a slow speed, or to a scenario where the dragging speed changes from a slow speed to a fast speed.

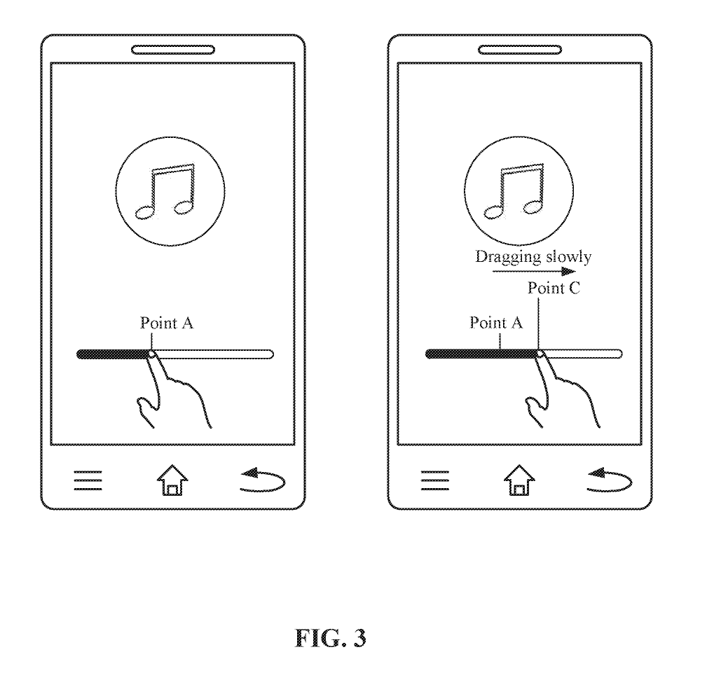

For example, as shown in FIG. 3, a user quickly drags a progress bar for an audio file to a point A, and then slowly drags the progress bar in the same direction to a point C without releasing the progress bar at the point A.

When the user desires to accurately adjust the playing progress of a media file, the user may continuously drag the progress bar for several times. Accordingly, in some embodiments, step 101 may further include determining whether the first operation is an operation in which a number of consecutive draggings of the progress bar within a preset time period is greater than a threshold value. If so, the first operation is determined to satisfy the preset operation condition.

In step 103, when the first operation satisfies the preset operation condition, a progress adjusting rule corresponding to the preset operation condition is determined.

In exemplary embodiments, the terminal device may pre-store a plurality of progress adjusting rules. Each of the progress adjusting rules corresponds to one type of operation condition, so as to ensure that an adjusting amplitude of the media file may be accurately calculated with respect to different types of operation conditions. Accordingly, step 103 may further include selecting a progress adjusting rule corresponding to the preset operation condition from the plurality of progress adjusting rules stored locally in the terminal device.

In step 104, a playing progress point of the media file is determined according to the selected progress adjusting rule and a second operation performed by the user with respect to the progress bar of the media file.

In the exemplary embodiment, the second operation is an operation that the user continues to drag the progress bar after the first operation is completed. From the perspective of the progress bar, the playing progress point is a position to which the sliding block in the progress bar currently slides. From the perspective of the playing of the media file, the playing progress point is a time point at which the media file currently plays. The first and second operations constitute an entire dragging operation of the user. After the entire dragging operation is completed, a playing progress point after the entire dragging operation is calculated according to the selected progress adjusting rule determined in step 103 and a playing progress point before the entire dragging operation.

In addition, after the end of the second operation, the progress adjusting rule may be restored to a default adjusting rule, i.e., when a normal dragging occurs again, the playing progress of the media file is adjusted according to the default adjusting rule.

Therefore, in the exemplary embodiment, a corresponding progress adjusting rule may be selected according to an operation type performed by the user. As such, the playing progress can be accurately adjusted to a playing progress point desired by the user, so that an excessive adjustment can be avoided.

In some embodiments, the above progress adjusting rule may include a proportional relation between a physical dragging distance of the progress bar and a progress adjusting amplitude of the media file. For example, the progress adjusting amplitude of the media file corresponding to a unit physical dragging distance of the progress bar during the first operation is greater than the progress adjusting amplitude of the media file corresponding to a unit physical dragging distance of the progress bar during the second operation.

For example, during the first operation, the progress adjusting amplitude of the media file may have a correspondence to the unit physical dragging distance of the progress bar, such as dragging 1 mm of the progress bar corresponding to skipping 60 seconds of the audio media file; and during the second operation, the progress adjusting amplitude of the media file may have a correspondence to the unit physical dragging distance of the progress bar, such as dragging 1 mm of the progress bar corresponding to skipping 10 seconds of the audio media file.

In one exemplary embodiment, the terminal device plays an audio file (e.g., an Audio.mp3 file), and the user presses and drags a progress bar of the audio file. In a process from starting dragging the progress bar to completing one dragging in which the progress bar is kept being pressed by the user, the audio file skips 60 seconds each time when the progress bar is dragged in the same direction by 1 mm. However, when the user accomplishes the one dragging and then drags the progress bar in an inverse direction or slows down the dragging speed without releasing his/her hand, an audio adjusting amplitude corresponding to dragging a unit physical dragging distance becomes smaller. For example, in this circumstance, each time the progress bar is dragged by 1 mm along the reverse direction, the audio file skips 10 seconds.

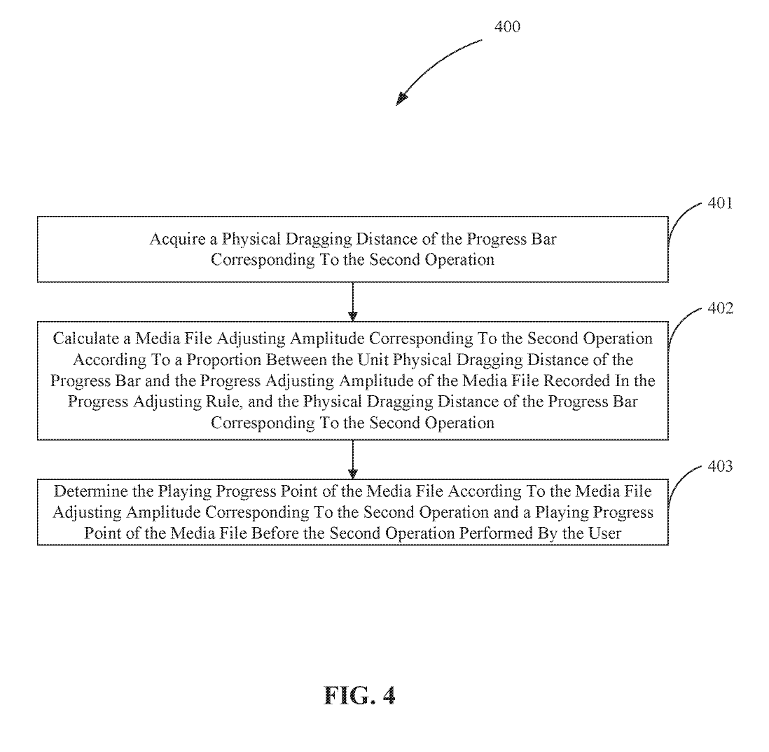

In some embodiments, step 104 may further include steps shown in FIG. 4, which is a flow chart for a method 400 for adjusting a playing progress of a media file.

In step 401, a physical dragging distance of the progress bar corresponding to the second operation is acquired.

For example, during a process from starting dragging the progress bar to completing such one dragging in which the progress bar is kept being pressed by the user, the sliding physical distance of the progress bar is 2 mm, and then the progress bar is dragged in a reverse direction by 1 mm. The physical dragging distance corresponding to the second operation is 1 mm.

In another example, during a process from starting dragging the progress bar to completing such one dragging in which the progress bar is kept pressed by the user, the sliding physical distance of the progress bar is 2 mm, and then the progress bar is dragged slowly in the same direction by 1 mm. The physical dragging distance of the progress bar corresponding to the second operation is 1 mm.

In step 402, a media file adjusting amplitude corresponding to the second operation is calculated according to a proportion between the unit physical dragging distance of the progress bar and the progress adjusting amplitude of the media file recorded in the progress adjusting rule, and the physical dragging distance of the progress bar corresponding to the second operation.

For example, during the second operation, if each time the progress bar is dragged in a direction by 1 mm, the audio file skips 10 seconds accordingly. As such, each time when the user drags slowly the progress bar in the same direction or drags the progress bar reversely by 1 mm, the adjusting amplitude of the audio file is 10 seconds (i.e., 10 seconds/mm*1 mm=10 seconds.)

In step 403, a playing progress point of the media file is determined according to the media file adjusting amplitude corresponding to the second operation and a playing progress point of the media file before the second operation is performed by the user.

For example, a playing progress point of the audio file before the above first operation performed by the user is at 1 minute and 20 seconds. During the first operation, every time the progress bar is dragged in a direction by 1 mm, the audio file skips 60 seconds. During a process from starting dragging the progress bar to completing such one dragging in which the progress bar is kept pressed by the user, a sliding physical distance of the progress bar is 2 mm. Then an adjusting amplitude of the audio file is 120 seconds (i.e., 60 seconds/mm*2 mm=120 seconds). Accordingly, the playing progress point of the above audio file after the above first operation performed by the user is at 3 minutes and 20 seconds (i.e., 1 minute and 20 seconds plus 120 seconds is the 3 minutes and 20 seconds).

At this time, if the progress bar is reversely dragged by 1 mm (i.e., a second operation is performed), the playing progress point of the media file after the second operation is at 3 minutes and 10 seconds (i.e., 3 minutes and 20 seconds−(10 seconds/mm*1 mm)=3 minutes and 10 seconds). Alternatively, if the progress bar is slowly dragged in the same direction by 1 mm, the playing progress point of the media file after the second operation is at 3 minutes and 30 seconds (i.e., 3 minutes and 20 seconds+(10 seconds/mm*1 mm)=3 minutes and 30 seconds).

In the exemplary embodiments, the dragging intention of the user during dragging the progress bar can be recognized. Based on the dragging intention of the user, the media file adjusting amplitude corresponding to the physical dragging distance is adaptively adjusted. In this way, the progress can be accurately adjusted to a desired progress point, so that an excessive adjustment can be avoided.

For making the progress adjustment more accurate, in some embodiments, the method 100 (FIG. 1) may further include the following steps.

When the above first operation satisfies the preset operation condition, the progress bar of the media file within a first progress range is enlarged and shown according to a preset presenting parameter, wherein a termination position of the first operation is located within the first progress range.

It can be appreciated that during dragging the progress bar by the user, when the progress bar is dragged near to the target progress point or the progress bar is slightly over-adjusted with respect to the target progress point, the user generally pauses the dragging operation, and then slows down the dragging of the progress bar or reversely drags the progress bar. In addition, enlarging and presenting the progress bar of the media file also facilitates the user to accurately adjust the progress bar. For this, a portion of the progress bar near the pausing position may be enlarged and shown.

It should be noted, the first progress range in the present exemplary embodiment may be, but is not limited to, 10 mm.

For example, when the first progress range is 10 mm, a progress bar within the 10 mm range to the left of the termination position of the first operation may be enlarged and presented; or a progress bar within the 10 mm range to the right of the termination position of the first operation may be enlarged and presented. Alternatively, a progress bar within a X mm range to the right of the termination position of the first operation may be enlarged and presented and a progress bar within a Y mm range to the left of the termination position of the first operation may be enlarged and presented, wherein X+Y=10 mm.

In the exemplary embodiments, the presenting parameter of the progress bar of the media file may be automatically adjusted according to the gesture operation intention of the user, such that the progress bar is adjusted to a size suitable for the user's operation and then is presented. In this way, it is convenient for the user to quickly and accurately adjust the playing progress of the media file.

Considering the diversity of the dragging operations and the requirements of the user for setting the progress adjusting rule according to his/her own needs, the present disclosure may provide the user with an interface for setting the progress adjusting rule. Accordingly, in some embodiments, the method 100 (FIG. 1) may further include the following steps. A progress adjusting rule setting operation inputted by the user is received, wherein the progress adjusting rule setting operation includes at least one progress adjusting rule customized by the user. The progress adjusting rule customized by the user is stored into the terminal device locally.

In another embodiment, the method 100 (FIG. 1) may further include the following steps. A progress adjusting rule modifying operation inputted by the user is received, wherein the progress adjusting rule modifying operation includes a modification parameter for modifying by the user at least one progress adjusting rule stored locally in the terminal device. The at least one progress adjusting rule stored locally in the terminal device is updated according to the modification parameter.

In the exemplary embodiments, an interface for setting the progress adjusting rule may be provided to the user. In this way, the requirement of the user for customizing the progress adjusting rule may be satisfied, and on the other hand, a calculation rule which matches the dragging operation may be provided, thereby improving the accuracy of the adjusting result.

It should be noted, although the operations of the methods of the present disclosure are described in a specific order in the drawings, it is not required or does not imply that these operations must be performed in the specific order, or the desired result can be only achieved by performing all the illustrated operations. The executing sequence of the steps depicted in the flow charts may be changed. Additionally or alternatively, some steps may be omitted, several steps may be combined into one step to be performed, and/or one step may be divided into multiple steps to be performed.

Corresponding to the above embodiments of the methods for adjusting playing progress of a media file, the present disclosure also provides embodiments of an apparatus for adjusting playing progress of a media file.

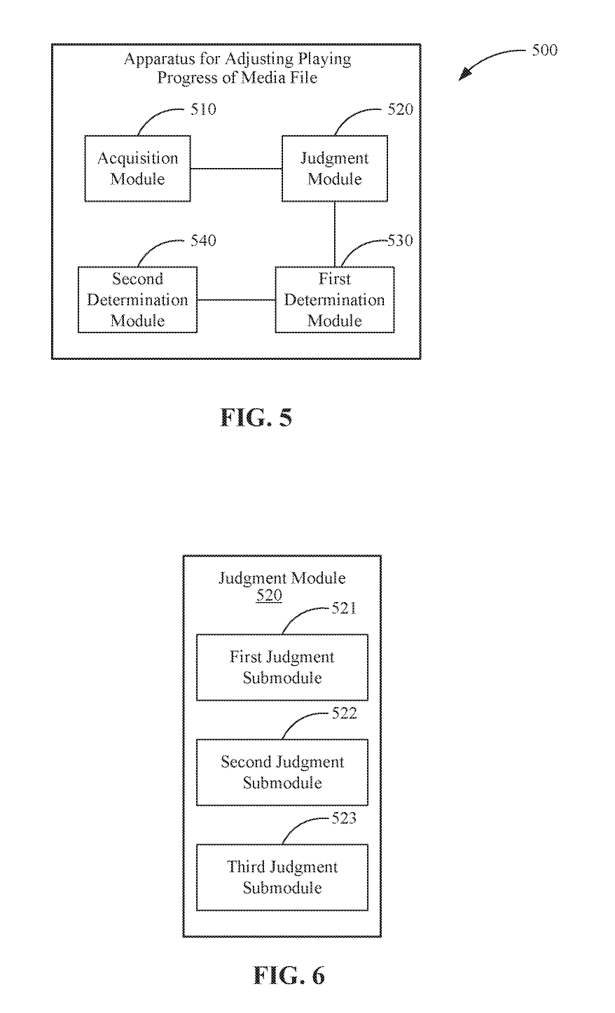

FIG. 5 is a block diagram of an apparatus 500 for adjusting a playing progress of a media file, according to an exemplary embodiment. As shown in FIG. 5, the apparatus 500 may include: an acquisition module 510, a judgment module 520, a first determination module 530, and a second determination module 540.

The acquisition module 510 is configured to acquire a first operation performed by a user with respect to a progress bar of the media file.

The judgment module 520 is configured to determine whether the first operation acquired by the acquisition module satisfies a preset operation condition.

The first determination module 530 is configured to determine a progress adjusting rule corresponding to the preset operation condition when the judgment module 520 determines that the first operation acquired by the acquisition module 510 satisfies the preset operation condition.

The second determination module 540 is configured to determine a playing progress point of the media file according to the progress adjusting rule determined by the first determination module 530 and a second operation performed by the user with respect to the progress bar of the media file.

In the exemplary embodiments, a corresponding progress adjusting rule may be selected according to an operation type of the user, such that the progress can be accurately adjusted to a playing progress point desired by the user, and an excessive adjustment can be avoided.

FIG. 6 is a block diagram of the judgment module 520 (FIG. 5), according to an exemplary embodiment. As shown in FIG. 6, the judgment module 520 may include: a first judgment submodule 521, a second judgment submodule 522, and a third judgment submodule 523.

The first judgment submodule 521 is configured to judge whether the first operation acquired by the acquisition module 510 (FIG. 5) is an operation in which the progress bar is reversely dragged during one time of dragging the progress bar. When the determination result is “yes”, the first operation is determined to satisfy the preset operation condition.

The second judgment submodule 522 is configured to judge whether the first operation acquired by the acquisition module 510 (FIG. 5) is an operation in which a variation in a dragging speed is greater than a preset value during one time of dragging the progress bar. When the determination result is “yes”, the first operation is determined to satisfy the preset operation condition.

The third judgement submodule 523 is configured to judge whether the first operation acquired by the acquisition module 510 (FIG. 5) is an operation in which a number of consecutive draggings within a preset time period is greater than a threshold value. When the determination result is “yes”, the first operation is determined to satisfy the preset operation condition.

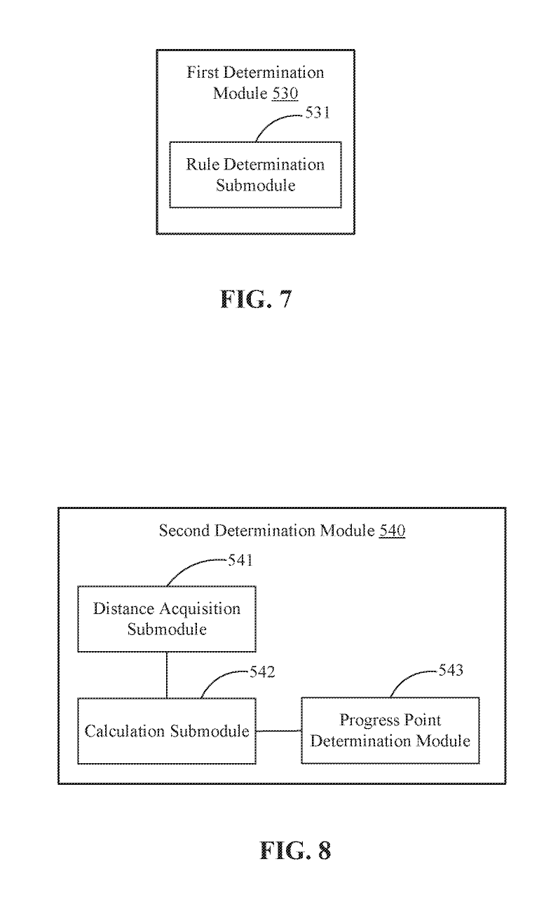

FIG. 7 is a block diagram of the first determination module 530 (FIG. 5), according to an exemplary embodiment. As shown in FIG. 7, the first determination module 530 may include a rule determination submodule 531.

The rule determination submodule 531 is configured to select a progress adjusting rule corresponding to the preset operation condition from a plurality of progress adjusting rules stored locally in a terminal device.

In some embodiments, the progress adjusting rule may include: a proportional relation between a physical dragging distance of the progress bar and a progress adjusting amplitude of the media file, wherein the progress adjusting amplitude of the media file corresponding to a unit physical dragging distance of the progress bar during the first operation is greater than the progress adjusting amplitude of the media file corresponding to a unit physical dragging distance of the progress bar during the second operation.

FIG. 8 is a block diagram of the second determination module 540 (FIG. 5), according to an exemplary embodiment. As shown in FIG. 8, the second determination module 540 may include: a distance acquisition submodule 541, a calculation submodule 542, and a progress point determination submodule 543.

The distance acquisition submodule 541 is configured to acquire a physical dragging distance of the progress bar corresponding to the second operation.

The calculation submodule 542 is configured to calculate a media file adjusting amplitude corresponding to the second operation according to a proportion between the unit physical dragging distance of the progress bar and the progress adjusting amplitude of the media file recorded in the progress adjusting rule, and the physical dragging distance of the progress bar corresponding to the second operation.

The progress point determination submodule 543 is configured to determine the playing progress point of the media file according to the media file adjusting amplitude corresponding to the second operation and a playing progress point of the media file before the second operation performed by the user.

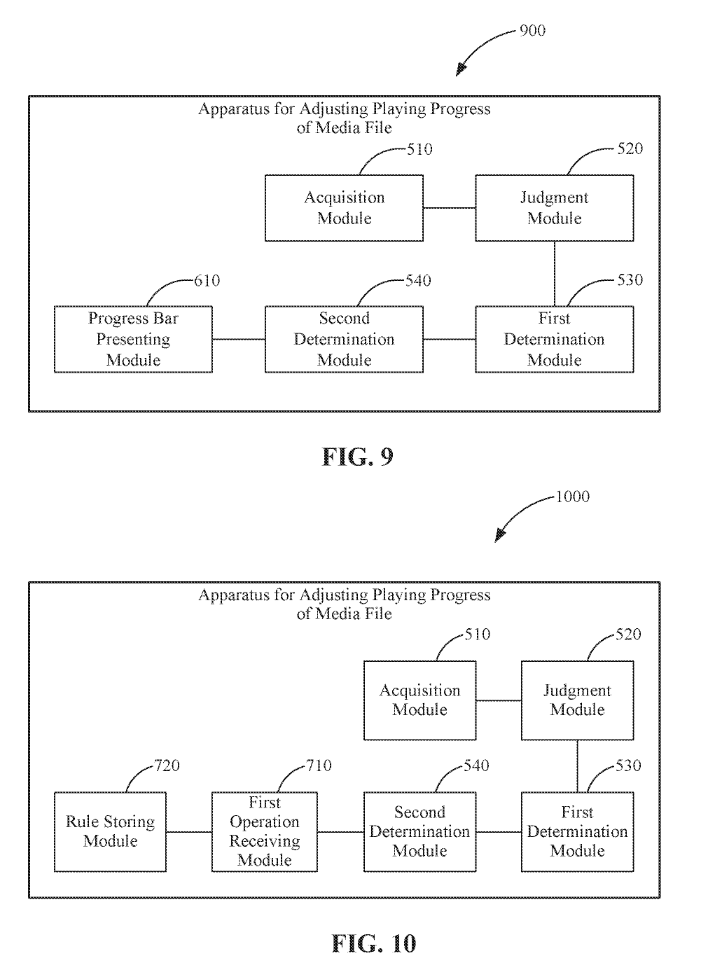

FIG. 9 is a block diagram of an apparatus 900 for adjusting playing progress of a media file, according to another exemplary embodiment. As shown in FIG. 9, the apparatus 900 may further include a progress bar presenting module 610.

The progress bar presenting module 610 is configured to, when the judgment module 520 determines that the first operation acquired by the acquisition module 510 satisfies the preset operation condition, enlarge and present the progress bar of the media file within a first progress range according to a preset presenting parameter, wherein the termination position of the first operation is located within the first progress range.

FIG. 10 is a block diagram of an apparatus 1000 for adjusting playing progress of a media file, according to another exemplary embodiment. As shown in FIG. 10, the apparatus 1000 may further include: a first operation receiving module 710 and a rule storing module 720.

The first operation receiving module 710 is configured to receive a progress adjusting rule setting operation inputted by the user, wherein the progress adjusting rule setting operation includes at least one progress adjusting rule customized by the user.

The rule storing module 720 is configured to store the progress adjusting rule customized by the user into the terminal device locally.

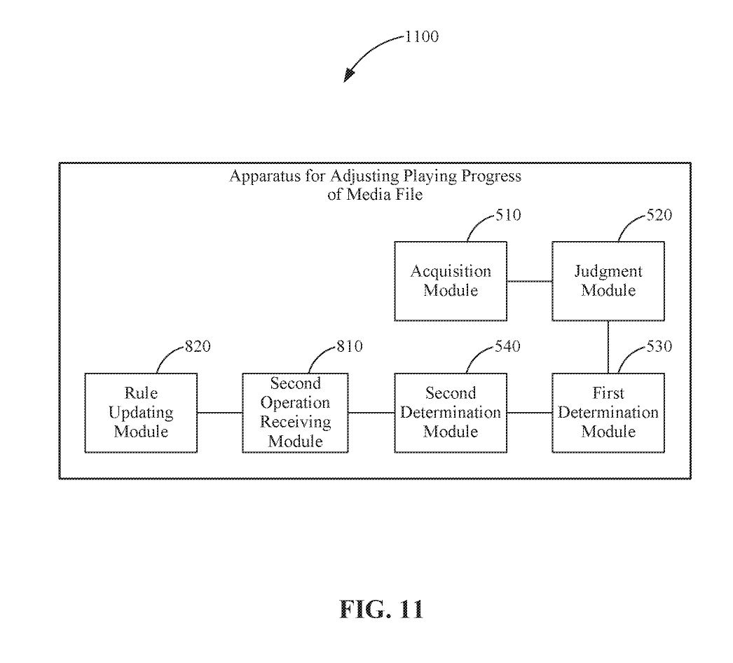

FIG. 11 is a block diagram of an apparatus 1100 for adjusting playing progress of a media file, according to another exemplary embodiment of the present disclosure. As shown in FIG. 11, the apparatus 1100 may further include: a second operation receiving module 810 and a rule updating module 820.

The second operation receiving module 810 is configured to receive a progress adjusting rule modifying operation inputted by the user, wherein the progress adjusting rule modifying operation includes a modification parameter for modifying by the user at least one progress adjusting rule stored locally in the terminal device.

The rule updating module 820 is configured to update the at least one progress adjusting rule stored locally in the terminal device according to the modification parameter.

With respect to the apparatuses in the above embodiments, the specific manners for performing operations by individual modules therein have been described in detail in the embodiments regarding the methods, which will not be repeated herein.

In addition, the present disclosure also provides an apparatus for adjusting playing progress of a media file, including: a processor; and a memory for storing instructions executable by the processor. The processor is configured to: acquire a first operation performed by a user with respect to a progress bar of the media file; determine whether the first operation satisfies a preset operation condition; when the first operation satisfies the preset operation condition, determine a progress adjusting rule corresponding to the preset operation condition; and determine a playing progress point of the media file according to the progress adjusting rule and a second operation performed by the user with respect to the progress bar of the media file.

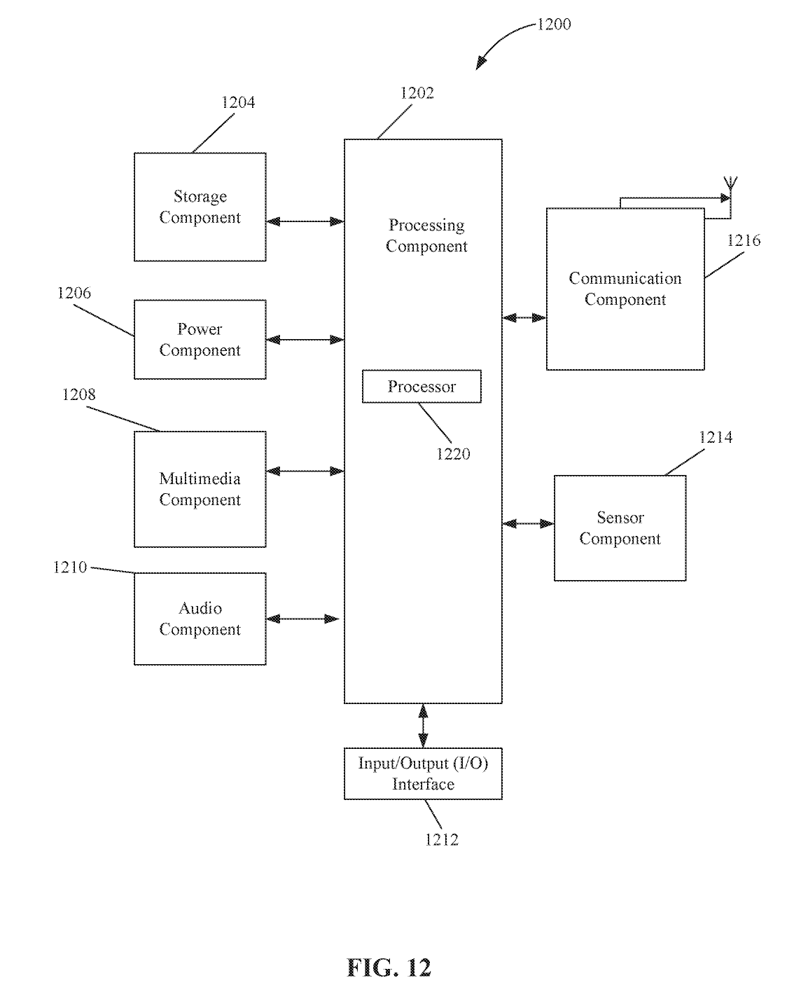

FIG. 12 is a block diagram of an apparatus 1200 for adjusting playing progress of a media file, according to an exemplary embodiment. For example, the apparatus 1200 may be a mobile phone, a computer, a digital broadcast terminal, a messaging device, a gaming console, a tablet, a medical device, exercise equipment, a personal digital assistant, an aircraft, and the like.

Referring to FIG. 12, the apparatus 1200 may include one or more of the following components: a processing component 1202, a storage component 1204, a power component 1206, a multimedia component 1208, an audio component 1210, an input/output (I/O) interface 1212, a sensor component 1214, and a communication component 1216.

The processing component 1202 typically controls overall operations of the apparatus 1200, such as the operations associated with display, telephone calls, data communications, camera operations, and recording operations. The processing component 1202 may include one or more processors 1220 to execute instructions to perform all or part of the steps in the above described methods. Moreover, the processing component 1202 may include one or more modules which facilitate the interaction between the processing component 1202 and other components. For instance, the processing component 1202 may include a multimedia module to facilitate the interaction between the multimedia component 1208 and the processing component 1202.

The storage component 1204 is configured to store various types of data to support the operation of the apparatus 1200. Examples of such data include instructions for any applications or methods operated on the apparatus 1200, contact data, phonebook data, messages, pictures, videos, etc. The storage component 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the apparatus 1200. The power component 1206 may include a power management system, one or more power sources, and any other components associated with the generation, management, and distribution of power in the apparatus 1200.

The multimedia component 1208 includes a screen providing an output interface between the apparatus 1200 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1208 includes a front camera and/or a rear camera. The front camera and the rear camera may receive an external multimedia datum while the apparatus 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a microphone (“MIC”) configured to receive an external audio signal when the apparatus 1200 is in an operation mode, such as a call mode, a recording mode, and a voice recognition mode. The received audio signal may be further stored in the storage component 1204 or transmitted via the communication component 1216. In some embodiments, the audio component 1210 further includes a loudspeaker used to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 includes one or more sensors to provide status assessments of various aspects of the apparatus 1200. For instance, the sensor component 1214 may detect an open/closed status of the apparatus 1200, relative positioning of components, e.g., the display and the keypad, of the apparatus 1200, a change in position of the apparatus 1200 or a component of the apparatus 1200, a presence or absence of user contact with the apparatus 1200, an orientation or an acceleration/deceleration of the apparatus 1200, and a change in temperature of the apparatus 1200. The sensor component 1214 may include a proximity sensor configured to detect the presence of nearby objects without any physical contact. The sensor component 1214 may also include a light sensor, such as a CMOS or CCD image sensor, for use in imaging applications. In some embodiments, the sensor component 1214 may also include an accelerometer sensor, a gyroscope sensor, a magnetic sensor, a pressure sensor, or a temperature sensor.

The communication component 1216 is configured to facilitate communication, wired or wirelessly, between the apparatus 1200 and other devices. The apparatus 1200 can access a wireless network based on a communication standard, such as WiFi, 2G, 3G, or 4G, or a combination thereof. In one exemplary embodiment, the communication component 1216 receives a broadcast signal or broadcast associated information from an external broadcast management system via a broadcast channel. In one exemplary embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the storage component 1204, executable by the processor 1220 in the apparatus 1200, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a terminal device to adjust a playing progress of a media file, comprising:
acquiring a first operation performed by a user with respect to a progress bar of the media file;
determining whether the first operation satisfies a preset operation condition;
when the first operation satisfies the preset operation condition, determining a progress adjusting rule corresponding to the preset operation condition; and
determining a playing progress point of the media file according to the progress adjusting rule and a second operation performed by the user with respect to the progress bar of the media file.

2. The method of claim 1, wherein the determining whether the first operation satisfies the preset operation condition comprises performing at least one of:
determining whether the first operation is an operation in which the progress bar is dragged reversely during one time of dragging the progress bar;
determining whether the first operation is an operation in which a variation in a dragging speed is greater than a preset value during one time of dragging the progress bar; and
determining whether the first operation is an operation in which a number of consecutive draggings within a preset time period is greater than a threshold value.

3. The method of claim 1, wherein the determining the progress adjusting rule corresponding to the preset operation condition comprises:
selecting the progress adjusting rule corresponding to the preset operation condition from a plurality of progress adjusting rules stored locally in the terminal device.

4. The method of claim 1, wherein the progress adjusting rule comprises:
a proportional relation between a physical dragging distance of the progress bar and a progress adjusting amplitude of the media file, wherein the progress adjusting amplitude of the media file corresponding to a unit physical dragging distance of the progress bar during the first operation is greater than the progress adjusting amplitude of the media file corresponding to a unit physical dragging distance of the progress bar during the second operation.

5. The method of claim 4, wherein the determining the playing progress point of the media file according to the progress adjusting rule and the second operation performed by the user with respect to the progress bar of the media file comprises:
acquiring a physical dragging distance of the progress bar corresponding to the second operation;
calculating a media file adjusting amplitude corresponding to the second operation according to a proportion between the unit physical dragging distance of the progress bar and the progress adjusting amplitude of the media file recorded in the progress adjusting rule, and the physical dragging distance of the progress bar corresponding to the second operation; and
determining the playing progress point of the media file according to the media file adjusting amplitude corresponding to the second operation and a playing progress point of the media file before the second operation performed by the user.

6. The method of claim 1, further comprising:
when the first operation satisfies the preset operation condition, enlarging and presenting the progress bar of the media file within a first progress range according to a preset presenting parameter, wherein a termination position of the first operation is located within the first progress range.

7. The method of claim 1, further comprising:
receiving a progress adjusting rule setting operation inputted by the user, wherein the progress adjusting rule setting operation includes at least one progress adjusting rule customized by the user; and
storing the progress adjusting rule customized by the user into the terminal device locally.

8. The method of claim 1, further comprising:
receiving a progress adjusting rule modifying operation inputted by the user, wherein the progress adjusting rule modifying operation includes a modification parameter for modifying by the user at least one progress adjusting rule stored locally in the terminal device; and
updating the at least one progress adjusting rule stored locally in the terminal device according to the modification parameter.

9. An apparatus for adjusting playing progress of a media file, comprising:
a processor; and
a memory for storing instructions executable by the processor;
wherein the processor is configured to:
acquire a first operation performed by a user with respect to a progress bar of the media file;
determine whether the first operation satisfies a preset operation condition;
when the first operation satisfies the preset operation condition, determine a progress adjusting rule corresponding to the preset operation condition; and
determine a playing progress point of the media file according to the progress adjusting rule and a second operation performed by the user with respect to the progress bar of the media file.

10. The apparatus of claim 9, wherein the processor is further configured to perform at least one of:
determining whether the acquired first operation is an operation in which the progress bar is dragged reversely during one time of dragging the progress bar;
determining whether the acquired first operation is an operation in which a variation in a dragging speed is greater than a preset value during one time of dragging the progress bar; and
determining whether the acquired first operation is an operation in which a number of consecutive draggings within a preset time period is greater than a threshold value.

11. The apparatus of claim 9, wherein the processor is further configured to:
select the progress adjusting rule corresponding to the preset operation condition from a plurality of progress adjusting rules stored locally in the apparatus.

12. The apparatus of claim 9, wherein the progress adjusting rule comprises:
a proportional relation between a physical dragging distance of the progress bar and a progress adjusting amplitude of the media file, wherein the progress adjusting amplitude of the media file corresponding to a unit physical dragging distance of the progress bar during the first operation is greater than the progress adjusting amplitude of the media file corresponding to a unit physical dragging distance of the progress bar during the second operation.

13. The apparatus of claim 12, wherein the processor is further configured to:
acquire a physical dragging distance of the progress bar corresponding to the second operation;
calculate a media file adjusting amplitude corresponding to the second operation according to a proportion between the unit physical dragging distance of the progress bar and the progress adjusting amplitude of the media file recorded in the progress adjusting rule, and the physical dragging distance of the progress bar corresponding to the second operation; and
determine the playing progress point of the media file according to the media file adjusting amplitude corresponding to the second operation and a playing progress point of the media file before the second operation performed by the user.

14. The apparatus of claim 9, wherein the processor is further configured to:
when the first operation satisfies the preset operation condition, enlarge and present the progress bar of the media file within a first progress range according to a preset presenting parameter, wherein a termination position of the first operation is located within the first progress range.

15. The apparatus of claim 9, wherein the processor is further configured to:
receive a progress adjusting rule setting operation inputted by the user, wherein the progress adjusting rule setting operation includes at least one progress adjusting rule customized by the user; and
store the at least one progress adjusting rule customized by the user into the apparatus locally.

16. The apparatus of claim 9, wherein the processor is further configured to:
receive a progress adjusting rule modifying operation inputted by the user, wherein the progress adjusting rule modifying operation includes a modification parameter for modifying by the user at least one progress adjusting rule stored locally in a terminal device; and
update the at least one progress adjusting rule stored locally in the apparatus according to the modification parameter.

17. A non-transitory computer-readable storage medium having stored thereon instructions that, when executed by a processor in a terminal device, cause the terminal device to perform a method for adjusting playing progress of a media file, the method comprising:
acquiring a first operation performed by a user with respect to a progress bar of the media file;
determining whether the first operation satisfies a preset operation condition;
when the first operation satisfies the preset operation condition, determining a progress adjusting rule corresponding to the preset operation condition; and
determining a playing progress point of the media file according to the progress adjusting rule and a second operation performed by the user with respect to the progress bar of the media file.
